(19) United States
(12) Patent Application Publication
(10) Pub. No.: US 2010/0074990 A1
(43) Pub. Date: Mar. 25, 2010

(54) PROCESS FOR JOINING OF PIECES OF NATURAL CASING

(75) Inventors: Erik Torngaard Hansen, Copenhagen (DK); Kim Hansen, Copenhagen (DK); Knud Andersen, Copenhagen (DK)

Correspondence Address: DARBY & DARBY P.C., P.O. BOX 770, Church Street Station, New York, NY, 10008-0770, US

(73) Assignee: DAT-Schaub a.m.b.a., Copenhagen V (DK)

(21) Appl. No.: 12/517,115

(22) PCT Filed: Dec. 7, 2007
(86) PCT No.: PCT/DK07/00535

§ 371 Date: Sep. 23, 2009

(30) Foreign Application Priority Data
Dec. 8, 2006 (DK) PA 2006 01616

(51) Int. Cl. A22C 13/00; A23J 3/04; A23J 3/34; A23L 1/317

(52) U.S. Cl. 426/7; 426/138; 426/140; 426/89

(57) ABSTRACT

A process for firm joining of two or more pieces of natural casing together using transglutaminase at a low temperature to form desired dimensions, such as length, design and calibre.

### TECHNICAL FIELD OF THE INVENTION

The present invention concerns a process for firm joining of pieces of natural casing in order to form desired dimensions, i.e. lengths, designs and calibres (diameters) of casing.

### BACKGROUND OF THE INVENTION

It is desirable to join pieces of natural casing to get a certain length fitting the apparatus used for example preparing and treatment of sausages, or to prepare laminated casing products of desired dimensions from cut up casing.

Long pieces of casing have been achieved by sewing them together. However, such treatment is very work consuming, and the binding is not very strong.

It has also been proposed to prepare casings partially welded by using up to 200° C., but such a high temperature will spoil (cook) the casings.

Further it is common in the art to join pieces of casing by use of sodium hydroxide. However sodium hydroxide is as a chemical agent a strong base and can be etching and therefore not favoured in the processing area. It is inconvenient to use and it can in certain cases give the casing product an unwanted after-taste. The lamination with sodium hydroxide cannot stand to be soaked in water for longer times.

Glue has also been proposed, but no strong binding is achieved. The binding should be strong enough to stand a stay in water or brine.

From JP200112863 A and JP20044131741 A it is thus known to join casings by use of a lenient cross-binding adhesive, like e.g. animal proteins, such as collagen, gelatine, egg protein, lactoprotein, blood and muscle proteins. The adhesive is applied to at least one of the ends of the casing, whereafter the ends are pressed together.

Thus there is a need for firmly joining of pieces of natural casing without spoiling of the casings and without using potentially harmful chemicals.

A stronger joining is obtained by the method according to the invention without use of chemicals by using transglutaminase, which catalytically promotes the reaction between two pieces of casing. This leniently provides a strong joining capable of standing water and brine.

### SUMMARY OF THE INVENTION

The invention concerns a process for firm joining of two or more pieces of natural casing to form dimensions, i.e. lengths, designs and calibres, of natural casing, wherein two or more pieces of casing are joined using transglutaminase. This gives a strong, covalent binding.

The invention thus covers a catalyzed reaction between two pieces of natural casing to form desired lengths and catalyzed reaction between two or more pieces of casing to form desired laminated products.

### DETAILED DESCRIPTION OF THE INVENTION

In the present invention the term “natural casing” or “casing” is used for intestines from animals, such as pig, sheep, beef, cattle or horse, for use as casing for sausages or for other food products. Intestines from young animals, such as lamb and calf, are also covered. Intestines from other animals can be used. The casings can either be fresh or salted casings.

Salted casings will normally be slightly desalted in water before use in the present invention. The casing can be cut up.

Transglutaminases are a widely distributed group of enzymes that catalyse the formation of isopeptide bonds. This polymerization and cross-linking of proteins occurs through the formation of strong covalent bonds between protein molecules. Transglutaminases are already used in the food industry in a variety of food processes. The nutritional value is not lost using transglutaminases. The cross-linked proteins have no adverse effect and can be readily absorbed in the human body.

Transglutaminases useful in the present invention can be the commercial product ACTIVA™EB from AJINOMOTO, Japan, but are not limited to this product. Transglutaminase from AJINOMOTO is produced by fermentation. Transglutaminases are also found in many organisms of animal or vegetable origin:

| Mammals | Birds | Fish | Plants | Others |
|---|---|---|---|---|
| Human, pig, | Chicken, | Tuna, | Peas, | Shrimps, |
| cow, Sheep, | pigeon | mackerel | broccoli, | scallop, oyster |
| rabbit etc | etc | Salmon etc | spinach | |
| Liver, heart, | Gizzard, | Muscle, liver | Growing | Muscle, egg |
| kidney, blood | blood | | shoot, leaves | |

Transglutaminases are easily inactivated by raising the temperature:

| Temperature | Time required for inactivation |
|---|---|
| 65° C. | 2 hours |
| 70° C. | Within 15 min |
| 75° C. | Within 5 min |
| 80° C. | Within 1 min |

and the inactivated transglutaminase does not impair the quality of the food product.

The process of the invention is a process for firm joining of two or more pieces of natural casing to form desired lengths, designs or calibres of natural casing wherein two or more pieces of casing are joined using transglutaminase.

Every kind of transglutaminase is applicable in the invention.

Two or more pieces of natural casing can be joined to form a long casing useful for sausages. Normally this is done by applying transglutaminase powder evenly on one end, and the other end is pulled forward to create an overlap of not more than 0.5-2 cm, whereafter air bubbles are removed be a light pressure. It is enough to press by a finger stroke.

It is possible to use a larger overlap. However this is not necessary because of the very strong binding and would mean a larger waste, because sausages made using the casing will not be graded as first quality, if they have an overlap. They are normally destroyed.

It is possible to apply transglutaminase by sprinkling dry powder on one or both pieces of casing to be joined or to use any other way. Thus, it is also possible to use submission of one or both ends in a solution of transglutaminase or to use a brush or the like mean to apply the transglutaminase as a powder or a solution.

Two or more pieces of natural casing can after longitudinal cut of the casing be joined in layers after submission and stirring in a solution of transglutaminase in cold water and a light pressure. Thereby a laminated casing is formed. This can be done, but need not be done, on a mould.

In the preparation of laminates it is also possible to apply the transglutaminase in any way, for example as powder.

The temperature for the transglutaminase treatment is not critical as long as it is not damaging the casing or inactivating the transglutaminase. However, it will take more time to be effective at a low temperature.

It is normally enough to apply about 50-200 mg corresponding to 0.2-13 U of transglutaminase for an overlap of 0.5-2 cm on pig intestines. However, much larger amounts can be used without any harmful effects. A transglutamanase solution will normally be a 10-20% w/vol solution corresponding to 3-13 U/ml. However, this concentration is not critical. More transglutaminase will not harm the product in any way, but it is superfluously.

Normally a transglutaminase bath is prepared in water of a temperature of 0-10° C. Higher or lower temperatures can be used, as long as the transglutaminase is not inactivated.

Laminated casings are normally left over night at about 5-60° C. The temperature is not critical, so normal room temperature or normal refrigerator temperature can be used.

The invention is further illustrated by the following non limiting examples.

### Example 1

The wanted two parts of casing from pig were pulled on a tube leaving the two ends to be reacted towards each other. Transglutaminase powder “Activa EB” was sprinkled evenly on one end approximately 1½ cm, and the other piece was pulled forward to create a 0.5-2 cm or longer overlap. A slight pressure was applied to the overlap to remove/avoid air bubbles. This process may be repeated to create the desired length of the final casing. The product was covered with foil and left to react 45 min at 50° C. and thereafter overnight at room temperature.

### Example 2

The wanted two parts of casing from pig were pulled on a tube leaving the two ends to be reacted towards each other. Transglutaminase powder “Activa EB” was sprinkled evenly on one end approximately 1½ cm, and the other piece is pulled forward to create a 0.5-2 cm overlap. A slight pressure was applied to the overlap to remove/avoid air bubbles. The process may be repeated to create the desired length of the final casing. The product was covered with foil and left to react 10 hours at 5° C. This process may be repeated to create the desired length of the final casing.

### Example 3

The wanted two parts of casing from pig were pulled on a tube leaving the two ends to be reacted towards each other. Transglutaminase powder “Activa EB” was sprinkled evenly on one end approx. 1-1½ cm, and the other piece was pulled forward to create a 0.5-2 cm over lap. A slight pressure was applied to the overlap to remove/avoid air bubbles. The process may be repeated to create the desired length of the final casing. The product was covered with foil and left to react 10 hours at room temperature.

### Example 4

The wanted two parts of casing from pig were pulled on a tube leaving the two ends to be reacted towards each other. Transglutaminase powder “Activa EB” was sprinkled on the surfaces which should react evenly on both ends approximately 1-1½ cm and the other piece was pulled forward to create a 0.5-2 cm overlap. A slight pressure was applied on the overlap to remove/avoid air bubbles. This process may be repeated to create the desired length of the final casing. The product was covered with foil and left to react for at least 10 hours at 5° C.

### Example 5

The wanted one part of casing was pulled on a tube leaving the end to be dipped into the transglutaminase powder “Activa EB” to achieve an evenly spread enzyme. The second casing part was added to the tube with an overlap of 0.5-2 cm. A slight pressure was applied on the overlap to remove/avoid air bubbles. The rest of the second casing was pulled onto the tube. This process may be repeated to create the desired length of the final casing. The product was covered with foil and left to react 10 hours at room temperature.

### Example 6

### Lamination

A 10-20% w/vol solution of transglutaminase powder “Activa EB” was made up in cold water and the casing raw material (pig intestine) was added and stirred around and left for 0 to 5 min. The enzyme solution wetted casing was layered on a mould with an appropriate overlap in one, two or more layers. A slight pressure was applied on the overlap to remove/avoid air bubbles, whereafter the product was left to react overnight at 5-10° C.

### Example 7

### Lamination

A 10-20% w/vol solution of transglutaminase powder “Activa EB” was made up in cold water and the casing raw material (pig intestines) was added and stirred around and left for 0 to 5 min. The enzyme solution wetted casing was layered on a mould with an appropriate overlap in one, two or more layers. A slight pressure was applied on the overlap to remove/avoid air bubbles, whereafter the product was left to react overnight at 40-60° C.

### Example 8

### Lamination

The casing material (pig intestines) was layered on the mould and transglutaminase powder “Activa EB” was sprinkled to achieve an evenly spread enzyme on the areas to be reacted. Next layer(s) was/were added onto the first layer. A slight pressure was applied on the overlaps to remove/avoid air bubbles, whereafter the product was left to react overnight at 5-10° C.

### Example 9

### Lamination

The casing material (pig intestines) was layered on a mould and transglutaminase powder “Activa EB” was sprinkled to achieve an evenly spread enzyme on the areas to be reacted. Next layer(s) was/were added onto the first layer. A slight pressure was applied on the overlaps to remove/avoid air bubbles, whereafter the product was left to react overnight at 40-60° C.

1. A process for securely joining two or more pieces of natural casing to form desired lengths, designs or calibers of natural casing, which comprises applying transglutaminase to at least one of the casing pieces to be joined, and pressing the piece bearing the transglutaminase together with another piece of casing with which it is to react.

2. The process of claim 1, which comprises forming a casing including two or more pieces of natural casing of desired length by applying said transglutaminase to react to one of said pieces and pressing said pieces together.

3. The process of claim 1, which comprises forming a laminated casing.

4. The process of claim 2, which comprises applying transglutaminase powder evenly on one end of one piece of said casing, pulling the other end forward to create an overlap of not more than 0.5-2 cm, and removing or avoiding air bubbles by creating a light pressure on the overlap.

5. The process of claim 2, which comprises applying transglutaminase powder evenly on the ends to be joined and pulling one end forward to create an overlap between the two ends of not more than 0.5-2 cm, and creating a light pressure on the overlap to avoid or remove air bubbles.

6. The process of claim 3, which comprises cutting one layer of a length of casing in the longitudinal direction, submerging and stirring said length of casing in a solution of transglutaminase in cold water, layering two or more pieces of casing on one another, applying slight pressure to the layered pieces and allowing said pieces of casing to remain in said cold water for a predetermined time period.

7. A casing of desired length, design or caliber formed by joining two or more pieces of natural casing by a covalent binding between protein molecules, wherein said casing is obtainable by a process according to claim 1.

8. A casing comprising one or more joints obtained by a process according to claim 1.

9. A casing according to claim 7, wherein the casing is from pig, sheep, lamb, beef, cattle, calf, or horse.

10. A casing according to claim 7, wherein the casing is a fresh or salted casing.

11. A joining between two pieces of natural casing provided by forming a covalent binding between protein molecules of the pieces of natural casing, wherein said joining is obtainable by a process according to claim 1.

12. A joining according to claim 11, wherein the casing is from pig, sheep, lamb, beef, cattle, calf, or horse.

13. A joining according to claim 11, wherein the casing is a fresh or salted casing.

14. A laminated casing product formed by joining two or more pieces of natural casing by covalently binding between protein molecules, said laminated casing product being obtainable by a process according to claim 1.

15. A method of preparing a laminated casing product, which comprises:
preparing a casing according to claim 3, and
filling a product in the casing

16. A casing according to claim 8, wherein the casing is a fresh or salted casing.

17. A casing according to claim 9, wherein the casing is a fresh or salted casing.

18. The method of claim 15 wherein the product is a sausage.
